(19) United States
(12) Patent Application Publication
(10) Pub. No.: US 2006/0006151 A1
(43) Pub. Date: Jan. 12, 2006

(54) Extending the life of an amorphous hardface by introduction of pellets

(76) Inventor: Jerry N. McMicken, Sugar Land, TX (US)

Correspondence Address: Mark R Wisner;Wisner & Associated, 1177 West Loop South, Suite 400, Houston, TX, 77027-9012, US

(21) Appl. No.: 10/507,530

(22) PCT Filed: Mar. 11, 2003
(86) PCT No.: PCT/US03/07501

§ 371 Date: Jul. 11, 2005

Related U.S. Application Data
(60) Provisional application No. 60/363,620, filed on Mar. 12, 2002.

(51) Int. Cl. B23K 9/04

(52) U.S. Cl. 219/76.14

(57) ABSTRACT

Apparatus and method for hardfacing a workpiece such as a cylindrical hollow pipe. The workpiece is moved past a stationary deposition head and a pellet-metering device. The deposition head and pellet-metering device are spaced far enough apart that the hardening pellets are dispersed uniformly onto and throughout the depth of the molten puddle of hardfacing material on the workpiece, resulting in substantially uniform cooling throughout the thickness of the hardfacing material, thereby decreasing the likelihood of cracking and heat checking.

The present invention relates to hardfacing a metal surface, and more particularly, to deposition of amorphous hardfacing to a metal surface utilizing pellets to increase the hardness of the deposit throughout the weldment while rapidly cooling the interior of the weldment and speeding its solidification.

Amorphous hardfacings of relatively hard metals are applied to the surfaces of relatively softer substrate materials to help protect the substrate against surface damage such as erosion, galling, and corrosion. The hardfacing may be applied in several ways. In one approach, the hard metal is melted, contacted to the substrate, and allowed to solidify against the substrate. Although sometimes termed welding because the hardfacing deposit is joined to the substrate by solidification, this process is distinct from other types of welding wherein two solid pieces are joined together by a molten weldment.

In hardfacing by welding, a substrate is moved relative to a heat source and a source of hardfacing material. The hardfacing material initially forms a molten pool on the substrate surface and thereafter solidifies as the heat source moves away from the area and heat is removed from the molten pool. The heat input from the heat source is usually adjusted so that the underlying substrate is melted to a shallow depth at its surface. Consequently, the molten hardfacing material and the melted region at the surface of the substrate material locally mix with the result that, after solidification of the hardfacing, there is a good interfacial bond between the hardfacing deposit and the substrate.

While operable and widely used in the industry, hardfacing by welding has drawbacks in some applications. For instance, heat input into the substrate must be minimized to reduce cracking and heat checking. Cracking can occur at the surface of the weldment due to excess heat and different cooling rates of the surface and the interior of the weldment. Such stress relief cracks are acceptable in limited numbers and particular orientations. However, it is preferred to reduce the incidence of cracking because such cracking can lead to penetration of erosive or corrosive agents into and through the hardfacing overlay.

Additionally, it is difficult to apply a uniform hardfacing deposit to a curved surface such as a cylindrical pipe or shaft. The surface must be held horizontal, and the molten pool must be applied very near the top dead center of the horizontal region. Even then, because solidification requires a period of time, the surface must be moved relatively slowly so that the still-molten pool does not run down the curved surface, resulting in variations in the thickness of the deposit. This slow movement reduces the production rate, with adverse effects on the economics of the hardfacing processing.

In addition to the disadvantages and limitations listed here, there is always the need to provide a hardfacing, and a method of applying such hardfacing, to a workpiece that is more durable than known hardfacing, and it is a primary object of the present invention to provide a novel, hardfaced workpiece that is characterized by superior resistance to wear.

Another object of the present invention is to provide a hardfaced product that is economical to produce having a good interfacial bond between hardfacing and substrate.

Another object of the present invention is to provide a method of hardfacing a workpiece that provides a more constant rate of cooling of the weldment layer to decrease the incidence of stress relief cracking in materials to which the hardfacing is applied.

Another object of the present invention is to provide an apparatus for hardfacing a workpiece wherein the heat source of the deposition head is laterally separated from the pellet-metering device during the deposition operation to allow selection of a heat source that is appropriate to a particular hardfacing application.

Another object of the present invention is to provide a hardfacing apparatus with a deposition head and pellet-metering device that are movable independently of each other.

Another object of the present invention is to provide a method and apparatus for applying hardfacing to a substrate in which the hardfacing deposit is regular and uniform in its physical properties when applied to the substrate.

Still another object of the present invention is to provide a method, and an apparatus, for hardfacing a substrate whereby introduction of heat intc the workpiece is minimized due to rapid cooling of the hardfacing layer.

Another object of the present invention is to provide a hardfacing method that produces an improved hardfacing overlay on both flat and curved surfaces. The life of such hardfacings as amorphous metals is extended by cooling the weldment puddle throughout, thereby increasing the hardness and substantially lessening the incidence of stress cracking. The hardfacing is applied to curved surfaces more easily and with reduced process control limitations compared to conventional techniques and deposition rate is significantly increased, improving process economics. Also, because the metal is cooled quickly and evenly, heat input into the workpiece, or heat loading into the workpiece, is reduced, thereby minimizing the undesirable effects of heating the metal workpiece.

These objects, and the advantages, of the present invention are met by providing a a method of hardfacing a workpiece that comprises providing a workpiece having a workpiece surface, a deposition head, and a metering device for introducing hardening pellets into the weldment. The metering device is positioned remote from the deposition head and in spaced apart relationship to the workpiece surface. Molten hardfacing material is deposited onto the workpiece surface from the deposition head and the workpiece is moved relative to the hardfacing apparatus either by moving the workpiece, the heat source and hardfacing material, or both. As hardfacing material is deposited, the molten hardfacing passes from the source of hardfacing material into the gap between the deposition head and the pellet-metering device such that the hardfacing material deposited onto the workpiece surface remains molten as the workpiece and hardfacing apparatus move relative to each other. Although positioned remotely from the deposition head, the metering device is close enough that the hardening pellets are metered onto the molten surface of hardfacing material. As the molten pool of material passes under the metering device, hardening pellets are metered into or onto the molten hardmetal.

The hardening pellets reduce solidifying time by removing heat from the molten pool more rapidly than the air cooling utilized in known hardfacing methods. In addition, the pellets are introduced into or onto the molten weldment in even distribution across and throughout the thickness of the hardmetal, with the result that the hardfacing cools more evenly than can be achieved by air cooling from only the outer surface.

Alternatively, hardening pellets are injected into the molten pool of hardfacing material, for instance, by applying air pressure at the input to the pellet-metering device. There are several advantages to injecting the pellets, including improved dispersion (both over the surface of the molten hardmetal and down into the molten hardmetal) and the opportunity to increase the number of pellets injected into the hardmetal. Both improved dispersion and an increase in the number of pellets result in more even cooling of the hardmetal. Injection of pellets also offers the opportunity to utilize smaller pellets and the increased surface area of the smaller pellets likewise results in more even cooling of the hardmetal.

In one specific application, a hardfacing band is applied to the circumference of a cylindrical pipe such that the workpiece has a locally curved surface of relatively constant convex radius of curvature R_{c}. The pipe is rotated about its cylindrical axis under a stationary deposition head and a spaced-apart pellet-metering device. The injected hardening pellets reduce the requirement for tight process control and precise positioning of the deposition head. The cooling resulting from injection of the hardening pellets reduces the possibility of the molten hardmetal running down the curved surface. This method results in an increased deposition rate that may be nearly double that of conventional methods due to the faster cooling rate. Also, the mass of the pellets increases the thickness of the hardmetal weldment.

The present invention will now be described in detail by reference to the figures; a brief description of each is as follows:

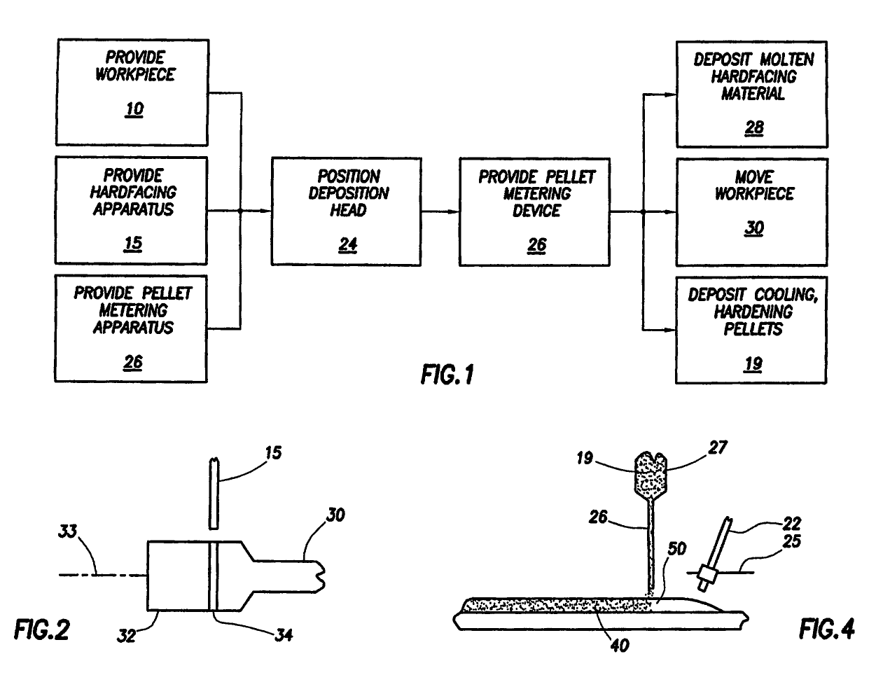

FIG. 1 is a schematic diagram of one embodiment of a method of hardfacing a surface in accordance with the teachings of the present invention.

FIG. 2 is a side, elevational diagram of an embodiment of an apparatus for hardfacing a surface constructed in accordance with the teachings of the present invention.

FIG. 3 is an end view of a hollow, cylindrical pipe that is in the process of being hardfaced by the method of FIG. 1.

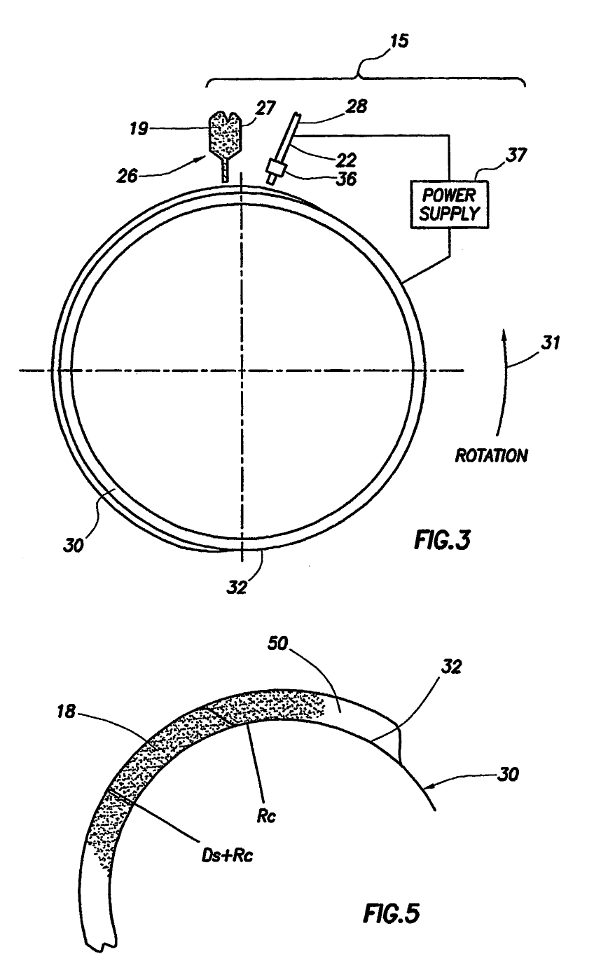

FIG. 4 is a detail diagram of the workpiece surface as the workpiece is being hardfaced in accordance with the method of FIG. 1.

FIG. 5 is an enlarged detail diagram of FIG. 3.

One method that is practiced in accordance with the present invention is shown in FIG. 1 and is utilized to apply hardfacing to a workpiece 30 at step 10 (FIG. 1). The hardfacing apparatus, designated generally at 15, and pipe 30 are shown in side view in FIG. 2. An amorphous hardfacing layer is applied to the surface 32 of pipe 30 in the form of circumferentially extending bands 34 that are typically ¾″ to 1″ wide and up to 3/16″ thick. As used herein, the term “workpiece” is intended to refer to metal that has been cast or otherwise formed into a useful article, and although reference is made herein to a hollow, cylindrical pipe 30, those skilled in the art will recognize from this description that the invention is also used to advantage to hardface metal surfaces of all shapes, such as those with irregularly curved and flat surfaces, and workpieces other than the pipe 30.

As shown in FIG. 3, hardfacing apparatus 15 includes two components, deposition head 22 and pellet-metering device 26, in spaced-apart relationship. Deposition head 22 heats and deposits molten amorphous or chrome carbide hardfacing onto workpiece surface 32 at a location spaced apart, or remote, from pellet-metering device 26. In the embodiment shown, deposition head 22 includes a hardfacing material source 28 in the form of a wire having the composition of the amorphous or chrome carbide hardfacing material. A heat source 35 includes an annular electrode 36 and power supply 37 that applies voltage between workpiece (pipe 30) and electrode 36 with appropriate controls (not shown) of a type known in the art. The hardfacing material from source 28 is fed through the interior of source 28 where it contacts electrode 36. Electrical current then flows through the circuit including power supply 37, pipe 30, and source 28, and electrode 36 heats the end of the hardfacing material source 28 as the material contacts surface 32. The hardfacing material from source 28 is melted to form a molten pool 50 (FIG. 4) on the surface 32 of pipe 30. The near surface region of pipe 30 is also typically melted to a shallow depth. The hardfacing material mixes with the melted base metal of pipe 30, resulting in a strong bond of hardfacing material to pipe upon later solidification.

Those skilled in the art will recognize that deposition head 22 may be any operable type including the electrical heating source shown, a laser, plasma source (MIG spray), or other operable heat source. Because deposition head 22 is remote from pellet-metering device 26, the design of one component is not constrained by the other or the requirement that they fit together in close proximity. Deposition head 22 is provided with means, in the form of a movable mount indicated generally at reference numeral 25 (FIG. 4), for moving the head closer to or further away from both pellet-metering device 26 and workpiece 30 as required for particular workpieces and for particular amorphous hardfacing materials. Those skilled in the art will also recognize that the pellet-metering device 26, or both deposition head 22 and pellet-metering device 26, can also be provided with movable mounting means for positioning their respective components relative to the workpiece and for obtaining the desired gap therebetween.

The hardfacing material may be any amorphous material. A preferred hardfacing, available from Liquid Metal's Armacor Division (Houston, Tex.), is known as Armacor M™ alloy, and has a composition in weight percent of about 27.75% chromium, about 6.0% nickel, about 3.45% boron, about 1.8% manganese, about 1.05% silicon, about 0.2% maximum carbon, balance iron or any chrome carbide based hardfacing material used for corrosion resistance, corrosion resistance, strength and corrosion resistance, and/or strength and erosion resistance. Another hardfacing material that may be used to advantage is referred to as “Super Hard Steel” and is described as a metallic alloy that has been transformed into a non-crystalline metallic glass (see http://www.inel.gov/featurestories/08-01r-d-branagan.shtml). It will be recognized, however, that the invention is not limited to the specific hardfacing materials described herein and that many other materials that are presently are presently commercially available and/or that may be developed in the future may be used to advantage in connection with the present invention.

The hardening pellets utilized in the apparatus of the present invention may be of any suitable material including steel, tungsten, chrome carbide, tungsten carbide, ceramic tungsten or other composite ceramic materials, or a mix of pellets comprised of such materials. A particular pellet that has been used to advantage is comprised of tungsten that melts at a temperature greater than about 1800° F. The pellets may be rounded (so as to maximize their surface area) and of a size selected in accordance with results that depend upon the particular application of the finished product and the particular materials utilized, all as may be determined by the skilled operator on the basis of repeated trials. Suitable results have been obtained with pellets sized to pass between screens of mesh sizes 16 to 28, but this size range is only representative of the sizes that may be utilized to advantage, it being possible to obtain the intended result with pellets that are much larger than 16 mesh and much smaller than 28 mesh. It will also be recognized that are shaped in shapes other than rounded may be utilized to advantage; for instance, sintered carbide has been utilized with satisfactory results. Because so many different materials, sizes, and shapes of pellets may be utilized for the purpose of cooling the molten puddle 50, reference is made herein to the introduction of “hardening pellets” into the pool 50 of molten hardfacing material.

Depending upon the application of the finished product and other variables such as the particular metal that is being hardfaced and the composition of the pellets, it may also be advantageous to utilize two (or more) pellet-metering devices (not shown) with pellets of different compositions, sizes, and/or shapes. It may, for instance, be advantageous to meter pellets that are comprised of a heavier (denser) material initially into the molten puddle from a first pellet-metering device so as to achieve deeper penetration of the pellets into the puddle for more even and rapid cooling deep in the puddle and then, as the workpiece is being rotated, meter smaller or lighter pellets, or pellets of different composition, into the molten puddle from a second pellet-metering device.

Also depending upon the application of the finished product and other variables such as the particular metal that is being hardfaced and the composition of the pellets, it may also be advantageous to grind the hard metal band once applied to workpiece 30 in a finishing operation. Because such grinding/finishing operations are known in the art, they are not described in detail herein.

The deposition head 22 is operated to feed and melt hardfacing material and form the molten pool 50 on the surface 32 of workpiece/pipe 30. Simultaneously, the pipe 30 is rotated about its cylindrical axis 33 in the direction indicated by the arrow 31 (FIG. 3). In this manner, molten material in the pool 50 is carried under the pellet-metering device 26 and pellets 19 are metered or injected into the molten puddle. It will also be recognized that, rather than moving the workpiece, deposition head 22 and pellet-metering device 26 may be moved relative to the workpiece.

Although it need not be at exactly the top, deposition head 22 is positioned at a circumferential location near the top-dead center position of pipe 30. The deposition head 22 is spaced a distance from the pipe 30 suitable for the particular type of deposition head selected in a manner known in the art. Pellet-metering device 26 is positioned radially adjacent to pipe 30 and circumferentially relative to, but remote from, deposition head 22. Pellet-metering device 26 is positioned near, but not necessarily on, the top-dead center of pipe 30 at a standoff distance that allows the proper amount of pellets 19 to be metered into the molten pool while assuring that the pellets 19 are metered into the molten puddle at a distance that is remote enough from the deposition head that they are not melted by the heat source 36. The standoff distance, or gap, between head 22 and device 26 is adjusted by moving head 22 on mount 25 to adjust the size of the gap so as to achieve the intended results as required for the particular size, shape, and composition of the pellets 19 that are being metered into the molten puddle. The gap is also adjusted according to whether one or two (or even more) pellet-metering devices 26 are being utilized. Other factors that may affect the size of this gap include the temperature of the heat source, the particular amorphous material that is being deposited by deposition head 22, ambient conditions, and the many other factors known to those skilled in the art of applying hardfacing to a substrate.

The pellet-metering device 26 may be any operable device capable of introducing a selected volume of pellets into the molten weld puddle at a preset rate. The system shown in the figures is comprised of a hopper 27 to hold the pellets 19 and a variable opening for dropping the pellets 19 (FIGS. 3 and 4) onto the metering device, the latter being comprised of a motor driven belt that controls the rate, volume, or rate and volume, of pellets introduced into the molten puddle. However, the references herein to a “pellet-metering device” are not intended to restrict the scope of the invention to a particular structure. Instead, that term is being used to refer to any structure that is advantageously used to introduce the pellets into or onto the molten pool 50 of hardfacing material. The term “introduce” (or “introducing”) is ufilized herein to describe the dispensing of the pellets to the molten pool of hardfacing material as a broad term that is intended to contemplate any suitable process by which the pellets depart the pellet-metering device 26 and end up on or in the molten pool 50. Included within the scope of the term “introducing” are such verbs as “metering,” “dispensing,” “dispersing,” “depositing,” “inserting,” and “injecting,” and it is contemplated that the pellets 19 may be metered, dispersed, dispensed, deposited, inserted or injected into or onto the molten pool 50 by gravity feed from a hopper 27, by extrusion caused by mechanical means acting on the pellets 19 contained in hopper 27, by a vacuum that pulls the pellets 19 from hopper 27, or by injection caused by application of pressure to the pellets 19 in hopper 27; any structure for accomplishing these (and equivalent) functions at a desired rate and volume is intended to be included within the scope of the term “introducing” and the phrase “introducing the pellets into or onto the molten pool of hardfacing material.”

When the pellets 19 contact the molten hardfacing material, the pellets tend to sink down into the liquid hardfacing material (hence the use of both the terms “into” and “onto” in characterizing the manner in which the pellets contact the molten pool 50), promoting even cooling of the pool 50. In one embodiment, the hardening pellets are injected into the molten pool of hardfacing material, for instance, by application of air pressure to the hopper 27. There are several advantages to injecting the hardening pellets into the molten hardmetal, including improved dispersion of the pellets (both over the surface of the molten hardmetal and down into the thickness Dₛ−R_{c} of the molten hardmetal) and the opportunity to increase the number of hardening pellets injected into the hardmetal. Both the improved dispersion and the increase in the number of hardening pellets result in more even cooling of the hardmetal. Injection of the pellets also offers the opportunity to utilize smaller pellets while still achieving satisfactory depth of penetration into the molten puddle 50, and the increased surface area of the smaller pellets likewise results in more even cooling of the hardmetal. Those skilled in the art will recognize, however, that similar advantages can be obtained by extrusion of the pellets 19 from hopper 27 and/or by pulling the pellets 19 from hopper 27 under vacuum. For improved safety in injecting the pellets 19 under pressure applied to hopper 27, and to decrease the likelihood of the adverse effects of any gases included in the pressurized air on the metal comprising the workpiece 30 or the amorphous hardfacing material 50, it is preferred to inject the pellets into the pool 50 by application of an inert gas such as nitrogen

In one embodiment, the hopper 27 of pellet-metering device 26 is agitated (for instance, by mechanical means (not shown)) during introduction of pellets 19 into the molten pool 50 of hardfacing material to decrease the likelihood of clumping of the pellets (for instance, from the inclusion of moisture) in hopper 27. If pellets 19 are introduced into the molten pool 50 by injection under air (or inert gas) pressure, agitation of hopper 27 also provides for passage of air or inert gas through the pellets 19 in hopper 27 onto the pool 50, thereby cooling pool 50 at a faster rate. A similar effect can be achieved by injecting the pellets 19 under pressurized, dried gas. In another embodiment, the pellets are injected by application of pressure with cold air or cold inert gas to both cool the pellets 19 in hopper 27 so that when the pellets 19 are introduced into the molten pool 50 they cause even faster, deep cooling of the liquid pool and so that the cold air or gas escapes from the pellet metering device 26 down onto the pool 50 to further promote the cooling of the molten pool 50.

The pellets 19 need not be injected under pressure to achieve accelerated deep cooling in the manner described in the preceding paragraph. Similar results are achieved by cooling the pellets before they are introduced into the molten pool 50. For instance, circulating a refrigerant through the walls of hopper 27 decreases the temperature of the pellets 19 contained therein before they are introduced into the pool 50.

FIGS. 4 and 5 illustrate the result of this spacing, or gap, between the deposition head 22 and metering device 26. The cooling effect of the pellets 19 introduced into the liquid puddle 50 results in a solidification rate that is substantially uniform throughout the thickness Dₛ-R_{c} of the hardmetal. In the embodiment shown, pellets 19 are dispensed from source 26 at a rate and injection pressure (if the pellet metering device injects the pellets) selected to assure dispersion of the pellets throughout the depth and breadth of puddle 50, thereby increasing the rapid cooling effect of the pellets and uniform cooling of the hardmetal. Rapid cooling, as well as uniformity of cooling, lessens the occurrence of stress cracking caused by cooling of the skin of the hardband material at a rate faster than the rate of the metal further into the thickness of the hardmetal band. Also, hardness is increased throughout the thickness Dₛ-R_{c} of the hardface material comprising band 34 as opposed to the surface hardness of hardface that results from the use of a conventional chilling-shaping shoe of the type known in the art, which only cools the outer surface.

The controlled, rapid, uniform deep cooling also allows hardfacing operations at a faster rate than in prior methods. In prior methods, the deposition head must be positioned very close to top-dead-center of the pipe and the pipe must be rotated slowly so that the molten pool solidifies before the pipe rotates far enough from the pellet source that molten hardfacing material runs down the surface of the pipe. In addition to the even cooling of the molten hardmetal, the introduction of the hardening pellets 19 at a point remote from the deposition head also acts to contain the liquid pool of hardmetal. This containment effect allows the pipe to be rotated much faster while the molten pool stays in the intended location, even on curved surfaces such as the exterior surface of pipe 30, thereby decreasing the time required to hardface the workpiece and reducing the cost of the hardfacing operation.

Field studies have demonstrated that the metallurgical structure of the hardfacing produced by the present approach is superior to that of hardfacing produced by known prior methods. In the case of hardfaced workpieces produced in accordance with the method of the present invention, field studies indicate that the life of the preferred amorphous metal was extended as compared to the amorphous metal applied without the addition of the hardening pellets.

The foregoing description of the preferred embodiment of the invention has been presented for purposes of illustration and description. It is not intended to be exhaustive or to limit the invention to the precise form disclosed, and many modifications and variations are possible in light of the above teaching without deviating from the spirit and the scope of the invention. The embodiment described is selected to best explain the principles of the invention and its practical application to thereby enable others skilled in the art to best utilize the invention in various embodiments and with various modifications as suited to the particular purpose contemplated. It is intended that the scope of the invention be defined by the claims appended hereto.

1. A method of hardfacing a workpiece comprising the steps of:
depositing a hardfacing material on a workpiece at a temperature high enough to create a molten puddle of the hardfacing material on the workpiece, and
introducing hardening pellets into the molten puddle on the workpiece while moving the workpiece, the hardening pellets being introduced into the molten puddle from a location remote from the point at which the hardfacing material is deposited on the workpiece, either the spacing between the point at which the hardfacing material is deposited onto the workpiece or the rate of movement of the workpiece being adjusted so that the hardfacing material remains molten until the hardening pellets are introduced into the molten puddle of hardfacing material.

2. The method of claim 1 wherein the pellets are introduced into the molten puddle by injection.

3. The method of claim 1 wherein the pellets are cooled before being introduced into the molten puddle.

4. The method of claim 1 wherein the pellets are comprised of a material selected from the group consisting of steel, tungsten, chrome carbide, tungsten carbide, and ceramic tungsten.

5. The method of claim 1 wherein the pellets are comprised of tungsten.

6. (canceled)

7. The method of claim 1 additionally comprising introducing pellets into the molten puddle at a second location remote from the point at which the hardfacing material is deposited on the workpiece.

8. The method of claim 7 wherein the pellets introduced into the molten puddle at a second location are of different size, shape, or composition than the pellets introduced into the molten puddle at the first location.

9. A hardfaced workpiece produced by the process of claim 1.

10. Apparatus for hardfacing a workpiece comprising:
means for moving a workpiece to be hardfaced;
a deposition head positioned relative to the workpiece for depositing a molten pool of hardfacing material on the workpiece; and
a pellet metering device positioned remote from said deposition head for intorducing hardening pellets into the molten pool of hardfacing material as the workpiece is moved.

11. The apparatus of claim 10 wherein said workpiece moving means moves the workpiece at a controlled rate, the rate of movement being selected to insure that the pellets penetrate down into the molten pool of hardfacing material.

12. The apparatus of claim 10 additionally comprising means for changing the position of said deposition head, said pellet metering device, or both said deposition head and said pellet metering device, relative to the workpiece, relative to each other, or both relative to the workpiece and each other.

13. The apparatus of claim 10 additionally comprising means for injecting the pellets into the molten pool of hardfacing material.

14. The apparatus of claim 10 additionally comprising means for cooling the pellets.

15. The apparatus of claim 10 additionally comprising means for controlling the rate, volume, or rate and volume of pellets introduced into the molten pool.
